(19) United States
(12) Patent Application Publication
(10) Pub. No.: US 2014/0085503 A1
(43) Pub. Date: Mar. 27, 2014

(54) Mobile Communication Apparatus and Flashlight Controlling Method

(71) Applicant: HTC CORPORATION, Taoyuan City (TW)

(72) Inventors: Wen-Yueh Su, Taoyuan City (TW); Hsu-Hsiang Tseng, Taoyuan City (TW)

(73) Assignee: HTC CORPORATION, Taoyuan City (TW)

(21) Appl. No.: 13/625,048

(22) Filed: Sep. 24, 2012

(51) Int. Cl. H04N 5/225; H04N 9/73

(52) U.S. Cl. 348/223.1; 348/371; 348/E05.026; 348/E09.051

(57) ABSTRACT

The invention discloses a mobile communication apparatus including an optical module, a flashlight module and a control unit. The optical module is configured for sensing an ambient color temperature of an ambient light. The flashlight module includes a plurality of light-emitting units. Each of the light-emitting units corresponds to a different spectrum band. The control unit is coupled to the optical module and the flashlight module respectively. According to the ambient color temperature of the ambient light, the control unit dynamically adjusts a relative intensity proportion between the light-emitting units while the flashlight module performing a lighting operation. In addition, a flash controlling method is also disclosed.

### BACKGROUND

1. Technical Field

The present disclosure relates to a mobile communication apparatus. More particularly, the present disclosure relates to a flashlight module on a mobile communication apparatus and a flashlight controlling method thereof.

2. Description of Related Art

With the rapid development of mobile communication devices, newly launched mobile phones equip with various kinds of functions. Among them, the photography function is regarded as an essential function of the mobile phone now. In addition, the mobile phone gradually replaces the feature of the digital camera.

Most image sensor units on the digital camera utilize a Charge-Coupled Device (CCD) or a Complementary Metal-Oxide Semiconductor (CMOS) to replace the feature of traditional photographic films. While taking photos, the ambient light while photo-shooting may be a mixture combining lights from different sources (such as natural light, fluorescent tubes, incandescent light bulb, etc.). Lights from different sources may have individual spectral characteristics, such that the ambient light mixed from them may have a different color temperature.

In addition, when the brightness of the ambient light is low, a flashlight is required to perform a lighting operation for improving the overall luminance of the scene, so as to get a clear image. The flashlights on traditional mobile communication devices usually utilize white light-emitting diodes (LED) to produce high-brightness white light for the lighting operation. However, while shooting at low brightness (e.g., shooting a night scene), some objects in the background are usually under a dim light with warm colors. In this case, the white light generated by the flashlight projects onto near objects (e.g., people), and accordingly the objects under the flashlight projection form white and bright areas with cold colors, which are discordant from the background. In other words, the objects under the flashlight projection have color temperatures different from the background color temperature, such that overall objects within the whole image are not harmony.

### SUMMARY

To solve the problems in the art, the invention provides a mobile communication apparatus and a flashlight controlling method thereof. A flashlight module of the mobile communication apparatus includes several light-emitting units corresponding to different spectrum bands respectively. The mobile communication apparatus senses the ambient color temperature (e.g., the ambient color temperature can be obtained by capturing a preview image, generating a white-balance information from the preview image, and determining the ambient color temperature from the white-balance information) at first, and then drives the plural light-emitting units with different intensity proportions according to the ambient color temperature, such that a mixed light formed by the light-emitting units may have a color temperature approaching to the ambient color temperature. Therefore, the objects under the flashlight projection may have the same color temperature as the objects of background, and the flashlight module may fulfill the brightness-enhancement function.

An aspect of the disclosure is to provide a mobile communication apparatus, which includes an optical module, a flashlight module and a control unit. The optical module is configured for sensing an ambient color temperature of an ambient light. The flashlight module includes a plurality of light-emitting units. Each of the light-emitting units corresponds to a different spectrum band. The control unit is coupled to the optical module and the flashlight module respectively. According to the ambient color temperature of the ambient light, the control unit dynamically adjusts a relative intensity proportion between the light-emitting units while the flashlight module performing a lighting operation.

According to an embodiment of the invention, the optical module includes a camera unit and a white-balance calculation unit. The camera unit is configured for capturing a first image under the ambient light. The white-balance calculation unit calculates automatic white-balance information based on the first image. The control unit obtains the ambient color temperature from the automatic white-balance information and dynamically adjusts the relative intensity proportion, so as to make a mixed light generated jointly by the light-emitting units to approach the ambient color temperature.

According to an embodiment of the invention, the light-emitting units of the flashlight module perform the lighting operation according to the relative intensity proportion after dynamic adjustment. The camera unit is configured for capturing a second image under the lighting operation.

According to an embodiment of the invention, the light-emitting units include a light-emitting unit with red color and a light-emitting unit with white color. In this embodiment, the control unit enhances a relative intensity of the light-emitting unit with red color if the ambient color temperature is more close to warm colors, and the control unit reduces the relative intensity of the light-emitting unit with red color if the ambient color temperature is more close to cold colors.

According to an embodiment of the invention, the light-emitting units include a light-emitting unit with red color, a light-emitting unit with green color and a light-emitting unit with blue color. In this embodiment, if the ambient color temperature is more close to warm colors, the control unit enhances a relative intensity of the light-emitting unit with red color or reduces a relative intensity of the light-emitting unit with blue color. On the other hand, if the ambient color temperature is more close to cold colors, the control unit reduces the relative intensity of the light-emitting unit with red color or enhances a relative intensity of the light-emitting unit with blue color.

Another aspect of the disclosure is to provide a flashlight controlling method suitable for a mobile communication apparatus, which includes a flashlight module with a plurality of light-emitting units. Each of the light-emitting units corresponds to a different spectrum band. The flashlight controlling method include steps of: sensing an ambient color temperature of an ambient light; dynamically adjusting a relative intensity proportion between the light-emitting units according to the ambient color temperature; and, driving the flashlight module to perform a lighting operation according to the relative intensity proportion.

According to an embodiment of the invention, the step of sensing the ambient color temperature of the ambient light further includes steps of: capturing a first image under the ambient light; calculating automatic white-balance information based on the first image; and, obtaining the ambient color temperature from the automatic white-balance information.

According to an embodiment of the invention, after performing the lighting operation according to the relative intensity proportion, the mobile communication apparatus captures a second image under the lighting operation, so as to complete an image capturing operation.

According to an embodiment of the invention, the step of dynamically adjusting the relative intensity proportion between the light-emitting units is configured to make a mixed light generated jointly by the light-emitting units to approach the ambient color temperature.

According to an embodiment of the invention, the light-emitting units comprise a light-emitting unit with red color and a light-emitting unit with white color. The flashlight controlling method includes steps of: if the ambient color temperature is more close to warm colors, enhancing a relative intensity of the light-emitting unit with red color; and, if the ambient color temperature is more close to cold colors, reducing the relative intensity of the light-emitting unit with red color.

According to an embodiment of the invention, the light-emitting units comprise a light-emitting unit with red color, a light-emitting unit with green color and a light-emitting unit with blue color. The flashlight controlling method includes steps of: if the ambient color temperature is more close to warm colors, enhancing a relative intensity of the light-emitting unit with red color or reducing a relative intensity of the light-emitting unit with blue color; and, if the ambient color temperature is more close to cold colors, reducing the relative intensity of the light-emitting unit with red color or enhancing a relative intensity of the light-emitting unit with blue color.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference to the accompanying drawings as follows:

FIG. 1 is a schematic diagram illustrating a mobile communication apparatus according to an embodiment of the invention;

FIG. 2 is a schematic diagram illustrating spectrum distribution of lights from the light-emitting unit and the light emitting unit;

FIG. 3 is a schematic diagram illustrating a mobile communication apparatus according to another embodiment of the invention;

FIG. 4 is a schematic diagram illustrating spectrum distribution of lights from the light-emitting units;

FIG. 5 is a schematic diagram illustrating a flashlight controlling method according to an embodiment of the invention; and

FIG. 6 is a schematic diagram illustrating flows of the flashlight controlling method operating on a mobile communication apparatus in an operational practice.

### DESCRIPTION OF THE EMBODIMENTS

In the following description, several specific details are presented to provide a thorough understanding of the embodiments of the present disclosure. One skilled in the relevant art will recognize, however, that the present disclosure can be practiced without one or more of the specific details, or in combination with or with other components, etc. In other instances, well-known implementations or operations are not shown or described in detail to avoid obscuring aspects of various embodiments of the present disclosure.

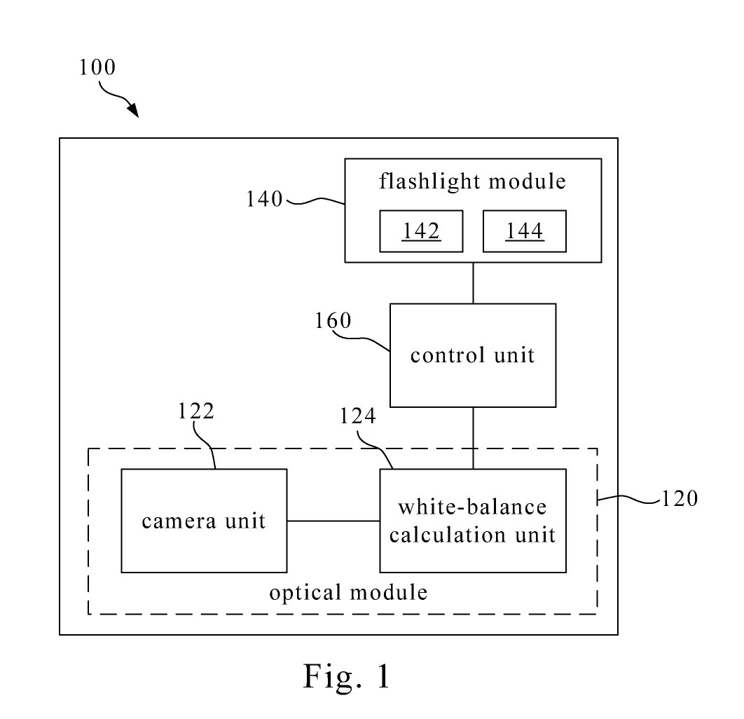

Reference is made to FIG. 1, which is a schematic diagram illustrating a mobile communication apparatus 100 according to an embodiment of the invention. As shown in FIG. 1, the mobile communication apparatus 100 includes an optical module 120, a flashlight module 140 and a control unit 160.

The optical module 120 is configured for sensing an ambient light. In the embodiment, the optical module 120 includes a camera unit 122 and a white-balance calculation unit 124. Before generating the final result of a captured image, the camera unit 122 is configured to capture a first image under the ambient light in advance. In practical applications, the first image can be a preview image. The first image is the original image taken under the ambient light without extra luminance supplements (e.g., a lighting operation by a flashlight module). If the intensity of current ambient light is low, the first image without extra luminance supplements in this case will shows a scene with dim colors. The colors shown in the first image without extra luminance supplements will be affected directly by an ambient color temperature of the ambient light.

In this case, the white-balance calculation unit 124 is configured to calculate automatic white-balance (AWB) information based on the first image. The AWB information of the first image includes optimal compositional parameters for constructing the white-color and a reference value of the color temperature corresponding to the first image. The reference value of the color temperature of the first image is directly related to the ambient color temperature. Therefore, the ambient color temperature of the ambient light can be obtained according to the AWB information calculated from the first image.

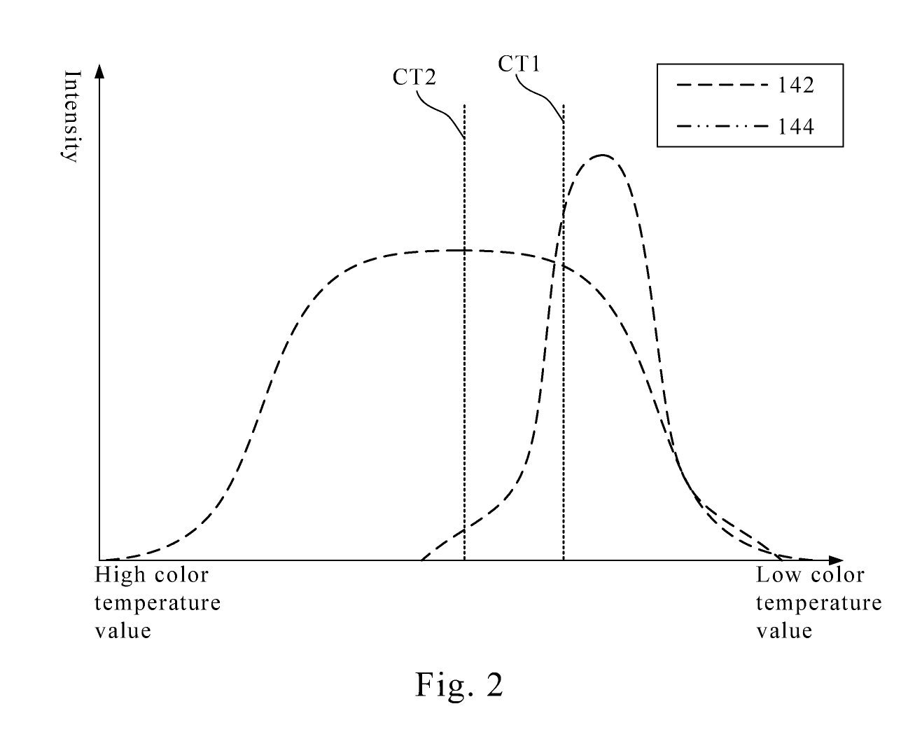

In the embodiment, the flashlight module 140 includes plural light-emitting units (such as light-emitting units 142 and 144 shown in FIG. 1). Each of the light-emitting units 142 and 144 corresponds to a different spectrum band. In this embodiment, the flashlight module 140 includes the light-emitting unit 142 with red color and the light-emitting unit 144 with white color. Reference is also made to FIG. 2, which is a schematic diagram illustrating spectrum distribution of lights from the light-emitting unit 142 and the light emitting unit 144.

As shown in FIG. 2, the spectrum distribution of light from the light-emitting unit 142 with red color is more close to the warm colors (i.e., low color temperature value). The spectrum distribution of light from the light-emitting unit 144 with white color is evenly spread from the warm colors (i.e., low color temperature value) to the cold colors (i.e., high color temperature value).

In this embodiment, when the ambient color temperature is more close to warm colors (e.g., the ambient color temperature CT1 shown in FIG. 2), the control unit 160 enhances a relative intensity of the light-emitting unit 142 with red color. On the other hand, when the ambient color temperature is more close to cold colors (e.g., the ambient color temperature CT2 shown in FIG. 2), the control unit 160 reduces the relative intensity of the light-emitting unit 142 with red color.

The control unit 160 is coupled to the optical module 120 and the flashlight module 140 respectively. According to the ambient color temperature of the ambient light, the control unit 160 dynamically adjusts a relative intensity proportion between the light-emitting units 142 and 144 while the flashlight module performing a lighting operation (for the luminance supplement), so as to make a mixed light generated jointly by the light-emitting units 142 and 144 during the light operation to approach the ambient color temperature.

Afterward, while generating the final result of the captured image, the light-emitting units 142 and 144 of the flashlight module 140 performs the lighting operation according to the relative intensity proportion after dynamic adjustment. At the time, the camera unit 122 is configured for capturing a second image under the lighting operation. The second image is regarded as the final result of the captured image.

In other words, the camera unit 122 in this embodiment may capture the first image (i.e., the preview image) at first in order to calculate the ambient color temperature. Then, the relative intensity proportion between the light-emitting units of the flashlight module 140 is adjusted according to the ambient color temperature. The lighting operation is performed based on the relative intensity proportion after dynamic adjustment. The camera unit 122 captures the second image (i.e., the final result of captured image) during the lighting operation. Therefore, the supplemental light provided by the flashlight module 140 has a color temperature approaching to the background. Besides, no additional sensors are needed in this embodiment for sensing the ambient color temperature. However, the invention is not limited to this. In another embodiment, the optical module 120 may include a specific optical sensor (not shown) for sensing the ambient color temperature of the ambient light. The specific optical sensor may provide the ambient color temperature to the control unit 160 as a reference in dynamically adjusting the relative intensity proportion between the light-emitting units 142˜144 of the flashlight module 140 during the lighting operation.

In aforesaid embodiment, the flashlight module 140 includes two light-emitting units 142 and 144 (for generating lights with red color and white color) corresponding to different spectrum bands, but the invention is not limited thereto. In another embodiment, the light-emitting units 142 and 144 may generate lights with blue and white colors, red and cyan colors, blue and yellow colors, or other equivalent combination of colors.

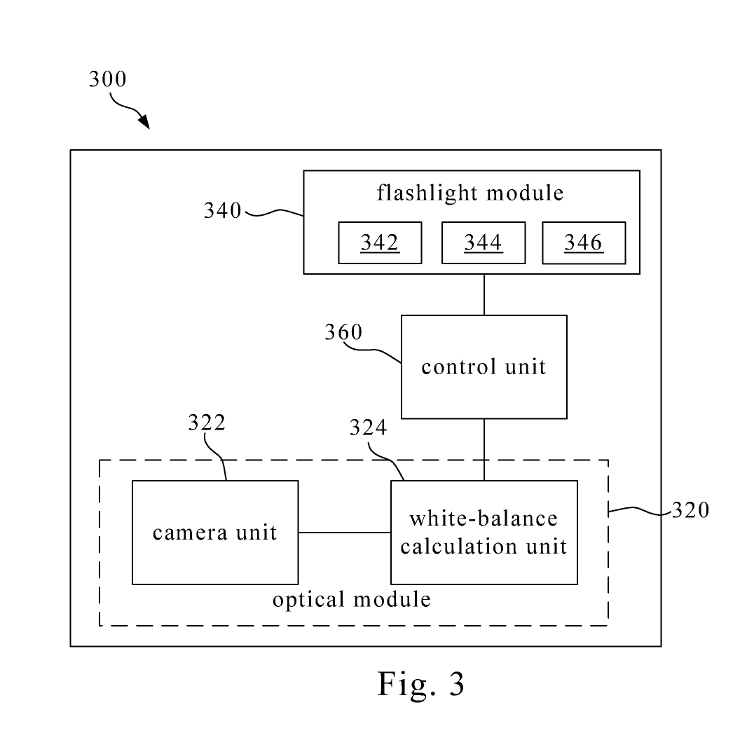

Reference is made to FIG. 3, which is a schematic diagram illustrating a mobile communication apparatus 300 according to another embodiment of the invention. As shown in FIG. 3, the mobile communication apparatus 300 includes an optical module 320, a flashlight module 340 and a control unit 360. The main difference between the embodiments in FIG. 3 and FIG. 1 is that, the flashlight module 340 in the embodiment shown in FIG. 3 includes three light-emitting units 342, 344 and 346 corresponding to different spectrum bands. In an embodiment, the light-emitting units 342, 344 and 346 includes the light-emitting unit 342 with red color, the light-emitting unit 344 with red color with green color and the light-emitting unit 346 with blue color.

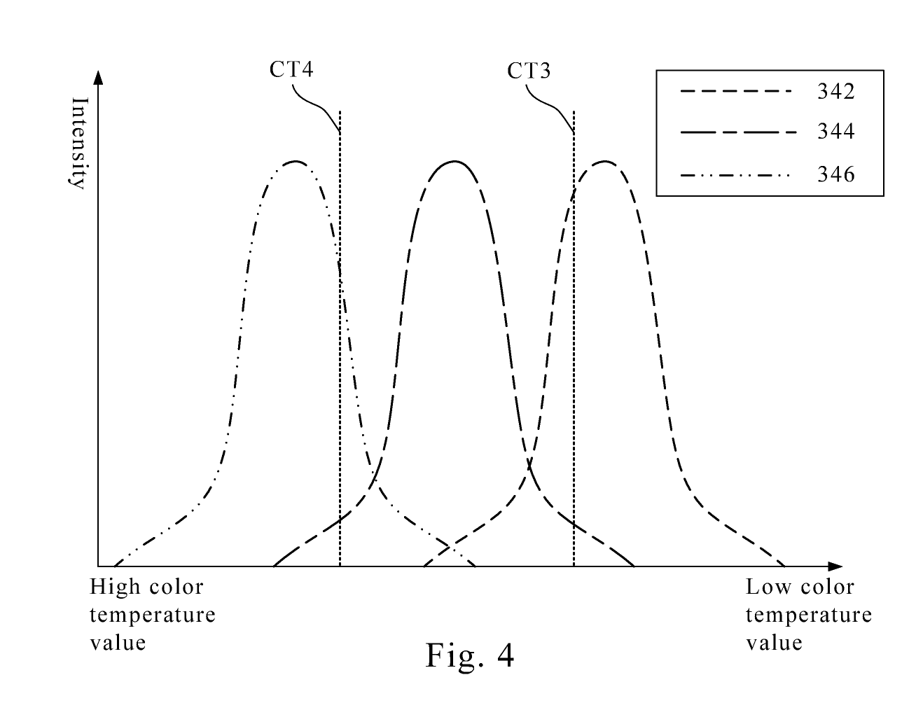

Reference is also made to FIG. 4, which is a schematic diagram illustrating spectrum distribution of lights from the light-emitting units 342, 344 and 346. In this embodiment, the optical module 320 is configured for sensing the ambient color temperature of the ambient light. The control unit 360 dynamically adjusts a relative intensity proportion between the light-emitting units 342, 344 and 346 according to the ambient color temperature of the ambient light.

As shown in FIG. 4, the spectrum distribution of light from the light-emitting unit 342 with red color is more close to the warm colors (i.e., low color temperature value). The spectrum distribution of light from the light-emitting unit 346 with blue color is more close to the cold colors (i.e., high color temperature value). The spectrum distribution of light from the light-emitting unit 344 with green color is located between aforesaid two light-emitting units 342 and 346.

In this embodiment, when the ambient color temperature is more close to warm colors (e.g., the ambient color temperature CT3 shown in FIG. 4), the control unit 360 enhances a relative intensity of the light-emitting unit 342 with red color or reduces a relative intensity of the light-emitting unit 346 with blue color. On the other hand, when the ambient color temperature is more close to cold colors (e.g., the ambient color temperature CT4 shown in FIG. 4), the control unit 360 reduces the relative intensity of the light-emitting unit 342 with red color or enhances a relative intensity of the light-emitting unit 346 with blue color.

According to the ambient color temperature of the ambient light, the control unit 360 dynamically adjusts the relative intensity proportion between the light-emitting unit 342˜346 of the flashlight module 340 during the lighting operation, so as to make a mixed light generated jointly by the light-emitting units 342˜346 to approach the ambient color temperature during the lighting operation.

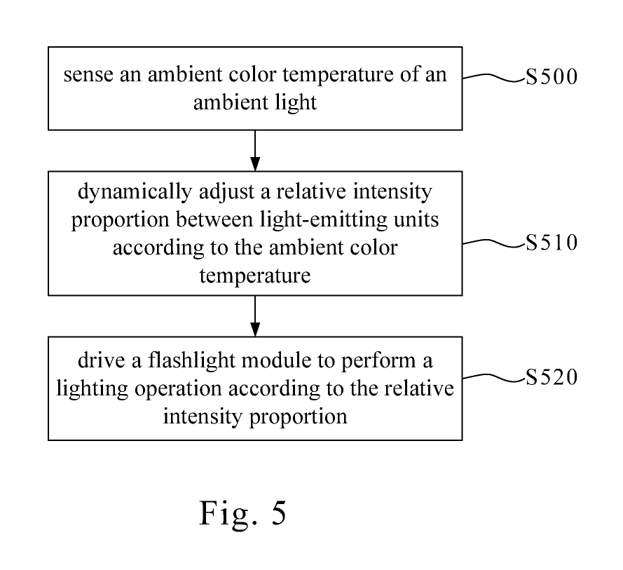

Reference is made to FIG. 5, which is a schematic diagram illustrating a flashlight controlling method according to an embodiment of the invention. The flashlight controlling method is suitable for a mobile communication apparatus, which includes a flashlight module with plural light-emitting units. Each of the light-emitting units corresponds to a different spectrum band. For example, the flashlight controlling method is suitable to be utilized on the mobile communication apparatus 100 or 300 in aforesaid embodiments, but the invention is not limited thereto.

As shown in FIG. 5, the flashlight controlling method executes step S500 at first for sensing an ambient color temperature of an ambient light.

Afterward, step S510 is executed for dynamically adjusting a relative intensity proportion between the light-emitting units (e.g., the light-emitting units 142˜144 of the embodiment shown in FIG. 1 or the light-emitting units 342˜346 of the embodiment shown in FIG. 3) according to the ambient color temperature. The step of dynamically adjusting the relative intensity proportion between the light-emitting units is configured to make a mixed light generated jointly by the light-emitting units to approach the ambient color temperature.

Afterward, step S520 is executed for driving the flashlight module to perform a lighting operation according to the relative intensity proportion after dynamic adjustment.

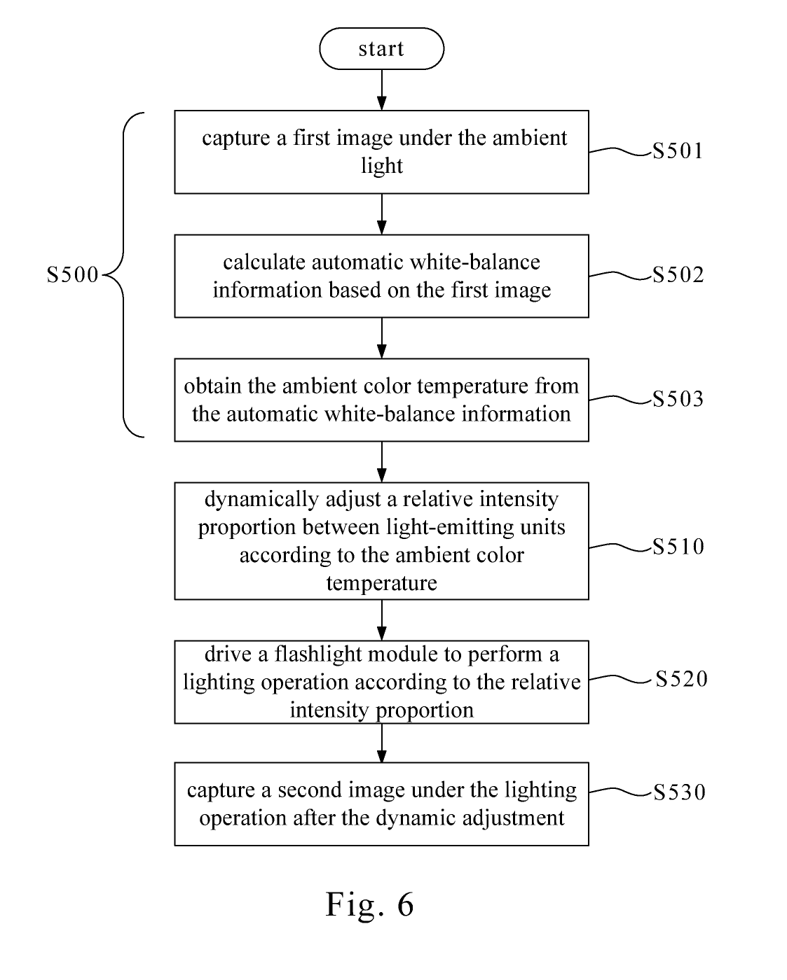

Reference is also made to FIG. 6, which is a schematic diagram illustrating flows of the flashlight controlling method operating on a mobile communication apparatus in an operational practice. In the operational practice shown in FIG. 6, the step of sensing the ambient color temperature of the ambient light (i.e., step S500 shown in FIG. 5) are completed by step S501 to step S503.

Step S501 is executed for capturing a first image under the ambient light. Afterward, step S502 is executed for calculating automatic white-balance information based on the first image. Afterward, step S503 is executed for obtaining the ambient color temperature from the automatic white-balance information.

According to an embodiment, the light-emitting units may include a light-emitting unit with red color and a light-emitting unit with white color. In this case, during the step S510 of dynamic adjusting the relative intensity proportion between the light-emitting unit, a relative intensity of the light-emitting unit with red color is enhanced if the ambient color temperature is more close to warm colors, or on the other hand, the relative intensity of the light-emitting unit with red color is reduced if the ambient color temperature is more close to cold colors (referring to the mobile communication apparatus 100 of the embodiment shown in FIG. 1 and FIG. 2).

According to an embodiment, the light-emitting units may include a light-emitting unit with red color, a light-emitting unit with green color and a light-emitting unit with blue color. In this case, during the step S510 of dynamic adjusting the relative intensity proportion between the light-emitting unit, if the ambient color temperature is more close to warm colors, a relative intensity of the light-emitting unit with red color is enhanced or a relative intensity of the light-emitting unit with blue color is reduced; or on the other hand, if the ambient color temperature is more close to cold colors, the relative intensity of the light-emitting unit with red color is reduced or a relative intensity of the light-emitting unit with blue color is enhanced (referring to the mobile communication apparatus 300 of the embodiment shown in FIG. 3 and FIG. 4).

In addition, when the flashlight controlling method executes step S520, the mobile communication apparatus has completed the dynamic adjustment on the flashlight module, the lighting operation can be performed according the relative intensity proportion after dynamic adjustment, and the flashlight controlling method is completed by the time.

Afterward, the mobile communication apparatus may further execute S530, capturing a second image (the final result of captured image) under the lighting operation after the dynamic adjustment, so as to complete an image capturing operation. Therefore, the flashlight controlling method may calibrate the output radiation of the flashlight module at first, in order to make the color temperature of the output radiation to approach the ambient color temperature, and then the optimal result image can be obtained via step 530.

Based on aforesaid embodiments, the invention provides a mobile communication apparatus and a flashlight controlling method thereof. A flashlight module of the mobile communication apparatus includes several light-emitting units corresponding to different spectrum bands respectively. The mobile communication apparatus senses the ambient color temperature (e.g., the ambient color temperature can be obtained by capturing a preview image, generating a white-balance information from the preview image, and determining the ambient color temperature from the white-balance information) at first, and then drives the plural light-emitting units with different intensity proportions according to the ambient color temperature, such that a mixed light formed by the light-emitting units may have a color temperature approaching to the ambient color temperature. Therefore, the objects under the flashlight projection may have the same color temperature as the objects of background, and the flashlight module may fulfill the brightness-enhancement function.

As is understood by a person skilled in the art, the foregoing embodiments of the present disclosure are illustrative of the present disclosure rather than limiting of the present disclosure. It is intended to cover various modifications and similar arrangements included within the spirit and scope of the appended claims, the scope of which should be accorded with the broadest interpretation so as to encompass all such modifications and similar structures.

What is claimed is:

1. A mobile communication apparatus, comprising:
an optical module configured for sensing an ambient color temperature of an ambient light;
a flashlight module comprising a plurality of light-emitting units, each of the light-emitting units corresponding to a different spectrum band; and
a control unit coupled to the optical module and the flashlight module respectively; wherein the control unit dynamically adjusts a relative intensity proportion between the light-emitting units according to the ambient color temperature of the ambient light while the flashlight module performs a lighting operation.

2. The mobile communication apparatus as claimed in claim 1, wherein the optical module comprises a camera unit and a white-balance calculation unit, the camera unit is configured for capturing a first image under the ambient light, the white-balance calculation unit calculates automatic white-balance (AWB) information based on the first image, the control unit obtains the ambient color temperature from the automatic white-balance information and dynamically adjusts the relative intensity proportion, so as to make a mixed light generated jointly by the light-emitting units to approach the ambient color temperature.

3. The mobile communication apparatus as claimed in claim 2, wherein the light-emitting units of the flashlight module perform the lighting operation according to the relative intensity proportion after dynamic adjustment, and the camera unit is configured for capturing a second image under the lighting operation.

4. The mobile communication apparatus as claimed in claim 1, wherein the light-emitting units comprise a light-emitting unit with red color and a light-emitting unit with white color.

5. The mobile communication apparatus as claimed in claim 4, wherein the control unit enhances a relative intensity of the light-emitting unit with red color if the ambient color temperature is more close to warm colors, and the control unit reduces the relative intensity of the light-emitting unit with red color if the ambient color temperature is more close to cold colors.

6. The mobile communication apparatus as claimed in claim 1, wherein the light-emitting units comprise a light-emitting unit with red color, a light-emitting unit with green color and a light-emitting unit with blue color.

7. The mobile communication apparatus as claimed in claim 6, wherein if the ambient color temperature is more close to warm colors, the control unit enhances a relative intensity of the light-emitting unit with red color or reduces a relative intensity of the light-emitting unit with blue color, and if the ambient color temperature is more close to cold colors, the control unit reduces the relative intensity of the light-emitting unit with red color or enhances a relative intensity of the light-emitting unit with blue color.

8. A flashlight controlling method, suitable for a mobile communication apparatus comprising a flashlight module with a plurality of light-emitting units, each of the light-emitting units corresponding to a different spectrum band, the flashlight controlling method comprising:
sensing an ambient color temperature of an ambient light;
dynamically adjusting a relative intensity proportion between the light-emitting units according to the ambient color temperature; and
driving the flashlight module to perform a lighting operation according to the relative intensity proportion.

9. The flashlight controlling method as claimed in claim 8, wherein the step of sensing the ambient color temperature of the ambient light further comprising:
capturing a first image under the ambient light;
calculating automatic white-balance (AWB) information based on the first image; and
obtaining the ambient color temperature from the automatic white-balance information.

10. The flashlight controlling method as claimed in claim 9, wherein after the flashlight module performs the lighting operation according to the relative intensity proportion, the mobile communication apparatus captures a second image under the lighting operation so as to complete an image capturing operation.

11. The flashlight controlling method as claimed in claim 8, wherein the step of dynamically adjusting the relative intensity proportion between the light-emitting units is configured to make a mixed light generated jointly by the light-emitting units to approach the ambient color temperature.

12. The flashlight controlling method as claimed in claim 8, wherein the light-emitting units comprise a light-emitting unit with red color and a light-emitting unit with white color, the flashlight controlling method comprising:
if the ambient color temperature is more close to warm colors, enhancing a relative intensity of the light-emitting unit with red color; and
if the ambient color temperature is more close to cold colors, reducing the relative intensity of the light-emitting unit with red color.

13. The flashlight controlling method as claimed in claim 8, wherein the light-emitting units comprise a light-emitting unit with red color, a light-emitting unit with green color and a light-emitting unit with blue color, the flashlight controlling method comprising:
if the ambient color temperature is more close to warm colors, enhancing a relative intensity of the light-emitting unit with red color or reducing a relative intensity of the light-emitting unit with blue color; and
if the ambient color temperature is more close to cold colors, reducing the relative intensity of the light-emitting unit with red color or enhancing a relative intensity of the light-emitting unit with blue color.
